(19) United States
(12) Patent Application Publication
(10) Pub. No.: US 2026/0294165 A1
(43) Pub. Date: Oct. 1, 2026

(54) SMART FOOD WARMING APPARATUS

(71) Applicant: GUANGDONG GOOD IMPRESSION INNOVATION TECHNOLOGY CO., LTD., Dongguan (CN)

(72) Inventors: Wenben WU, Dongguan (CN); Zhupeng ZHAN, Dongguan (CN); Yuanjin HUANG, Dongguan (CN)

(21) Appl. No.: 19/305,843

(22) Filed: Aug. 21, 2025

Related U.S. Application Data
(63) Continuation of application No. PCT/CN2025/115046, filed on Aug. 15, 2025.

(30) Foreign Application Priority Data
Mar. 25, 2025 (CN) 202520536553.2

(51) Int. Cl. A47J 36/24; H05B 1/02

(52) U.S. Cl. CPC A47J 36/2483; H05B 1/0261

(57) ABSTRACT

The present application relates to a smart food warming apparatus, including: a main controller; and a plurality of subsidiary warming plates; wherein the main controller is provided with a power interface configured for external connection to a power source to supply power to the main controller, and a plurality of operational interfaces corresponding in number to the subsidiary warming plates; a plurality of connection cables are respectively disposed between the plurality of operational interfaces and the plurality of subsidiary warming plates; the main controller is electrically connected between one or more of the plurality of subsidiary warming plates and one or more of the plurality of operational interfaces via corresponding ones of the plurality of connection cables; the plurality of connection cables are detachably connected to the plurality of operational interfaces, respectively; and the main controller is configured to regulate operating states of the plurality of subsidiary warming plates.

### CROSS-REFERENCE TO RELATED APPLICATION

The present application is a continuation of PCT application serial No. PCT/CN2025/115046, filed on Aug. 15, 2025, which claims the priority and benefits of Chinese patent application serial No. 202520536553.2, filed on Mar. 25, 2025. The entireties of Chinese patent application serial No. 202520536553.2 and PCT application serial No. PCT/CN2025/115046 are hereby incorporated by reference herein and made a part of the present application.

### TECHNICAL FIELD

The present application relates to a technical field of food warming, and in particular, to a smart food warming apparatus.

### BACKGROUND

A food warming plate is a small kitchen appliance that uses electric heating components to heat or maintain a constant temperature for food placed thereon. For example, when the indoor temperature is relatively low, and multiple dishes cannot be prepared simultaneously,, the cooked dishes will quickly cool down to room temperature, which affects their taste. The food warming plate can keep the dishes warm, allowing people to enjoy delicious dishes during the meal.

Existing food warming plates have a certain thickness and a limited effective heating area. Meanwhile, the table space is also limited. As a result, only a certain number of dishes can be placed on the food warming plate, and the remaining dinner plates with food can only be placed on the table outside the food warming plate, leading to low effective utilization of space. Additionally, when the food warming plate is in operation, heating elements thereof are all activated to uniformly warm or thermally maintain dishes placed thereon, resulting in relatively high power consumption that presents opportunities for energy efficiency improvements.

### SUMMARY

In order to facilitate thermal management of dishes, the present application provides a smart food warming apparatus.

The smart food warming apparatus provided in the present application adopts the following technical solution:

The smart food warming apparatus includes: a main controller; and a plurality of subsidiary warming plates; wherein the main controller is provided with a power interface configured for external connection to a power source to supply power to the main controller, and a plurality of operational interfaces corresponding in number to the subsidiary warming plates; a plurality of connection cables are respectively disposed between the plurality of operational interfaces and the plurality of subsidiary warming plates; the main controller is electrically connected between one or more of the plurality of subsidiary warming plates and one or more of the plurality of operational interfaces via corresponding ones of the plurality of connection cables; the plurality of connection cables are detachably connected to the plurality of operational interfaces, respectively; and the main controller is configured to regulate operating states of the plurality of subsidiary warming plates.

According to the above technical solution, the main controller is provided with a power interface through which the power supply to the main controller is realized. Meanwhile, the main controller is provided with a plurality of operational interfaces, and the number of subsidiary warming plates is adapted to the number of the operational interfaces. In addition, the main controller and the subsidiary warming plates are connected through connection cables. Users can freely control the number of subsidiary warming plates connected to the main controller as required. Only when a subsidiary warming plate is connected to the main controller via a cable will it operate, while unconnected subsidiary warming plates remain inactive. This design plays a positive role in reducing the overall energy consumption of the food warming apparatus. Additionally, the placement of the subsidiary warming plates on the dining table can be flexibly adjusted, enhancing space utilization without affecting the heating or heat preservation effect of dishes placed on the subsidiary warming plates. This design also contributes to improved heating or heat preservation effect of the dishes.

Optionally, each of the plurality of subsidiary warming plates comprises a base, and the base is provided with a containing groove, which is configured to accommodate one of the plurality of connection cables.

According to the above technical solution, when a subsidiary warming plate does not need to be connected to the main controller via a connection cable, the connection cable can be accommodated in the containing groove. This reduces the space occupied by the subsidiary warming plate, thereby facilitating the stacked storage of the plurality of subsidiary warming plates.

Optionally, each of the plurality of subsidiary warming plates comprises a placement portion configured to support a food container.

According to the above technical solution, the design of the placement portion enhances the stability of the dishes when placed on the subsidiary warming plates while also increasing the contact area between the dishes and the subsidiary warming plates. This allows the heat generated by the subsidiary warming plates to be better conducted to the dishes.

Optionally, when the connection cable is accommodated in the containing groove, the subsidiary warming plate is used for supporting a dinner plate or serving as a pad.

According to the above technical solution, when dishes currently placed on plates do not require heat preservation or heating (e.g., cold dishes), the subsidiary warming plates may be used as table pads, enhancing their practicality.

Optionally, each of the plurality of subsidiary warming plates comprises an insertion port; a distal end of one of the connection cables opposite to corresponding one of the plurality of operational interfaces is removably inserted into the insertion port of corresponding one of the plurality of subsidiary warming plates; and a sealing plug is provided at the insertion port and configured to seal the insertion port.

According to the above technical solution, since the insertion port is provided on the subsidiary warming plate, when the subsidiary warming plate is not in use, the connection cable can be detached from the insertion port, and the insertion port can be sealed with the plug. In this way, the subsidiary warming plate can be directly rinsed without foreign objects entering the plug interface, facilitating the cleaning of the subsidiary warming plate.

Optionally, the base is provided with a supporting structure.

According to the above technical solution, the support structure provided onto the base enhances heat dissipation capability of the base. This reduces the probability of damage to the dining table or placement surface caused by excessive temperature of the base.

Optionally, the main controller comprises a storage compartment formed thereon and configured to store the plurality of connection cables.

According to the above technical solution, a storage area provided on the main controller allows connection cables to be conveniently stored directly in the main controller. This significantly reduces the probability of the connection cables being lost due to inconvenient storage arrangements.

Optionally, the smart food warming apparatus further includes a master warming plate, and the main controller is disposed on the master warming plate.

According to the above technical solution, integrating the main controller into the master warming plate allows dishes to be placed on the master warming plate as well without affecting the normal operation of the main controller, thereby further improving the space utilization.

Optionally, each of the plurality of subsidiary warming plates comprises a base and a placement portion connected via liquid silicone; and a wiring groove is circumferentially formed on an upper surface of the base.

According to the above technical solution, the arrangement of the wiring groove enables the cables to be routed evenly and prevents the cables from being tangled or disorganized.

In summary, the present application provides at least one of the following beneficial technical effects:
1. Users can freely control the number of the subsidiary warming plates connected to the main controller as required. Only a subsidiary warming plate connected via a connection cable operate, while unconnected subsidiary warming plates remain inactive. This plays a positive role in reducing the overall energy consumption of the food warming apparatus, Additionally, the subsidiary warming plates can be flexibly positioned along the dining table, which is conducive to improving the space utilization of the dining tab;
2. When a subsidiary warming plate does not need to be connected to the main controller via a connecting cable, the connecting cable can be accommodated in the containing groove. This reduces the space occupied by the subsidiary warming plate, thereby facilitating the stacked storage of the plurality of subsidiary warming plates;
3. Integration of the main controller into the master warming plate allows dishes to be placed on the master warming plate as well without affecting the normal operation of the main controller, effectively improving the space utilization.

### BRIEF DESCRIPTION OF THE DRAWINGS

FIG. 1 is a structural schematic diagram of a subsidiary warming plate in a smart food warming apparatus of the present application.

FIG. 2 is a structural schematic diagram of some subsidiary warming plates connected to a main controller via connection cables in the smart food warming apparatus of the present application.

FIG. 3 is a structural schematic diagram of a plurality of subsidiary warming plates simultaneously connected to the main controller via connection cables in the smart food warming apparatus of the present application.

FIG. 4 is an overall structural schematic diagram of another embodiment of the smart food warming apparatus of the present application.

FIG. 5 is a schematic diagram of the assembly relationship between a base and a placement portion in the smart food warming apparatus of the present application.

### DETAILED DESCRIPTION

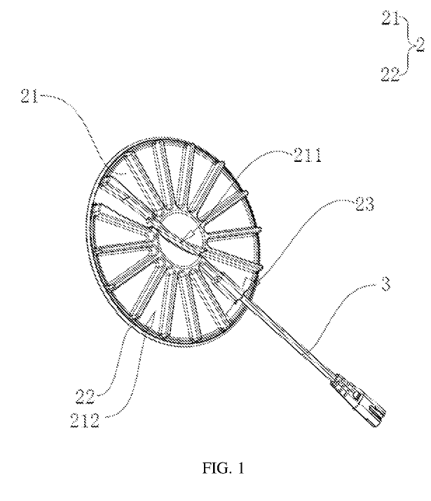

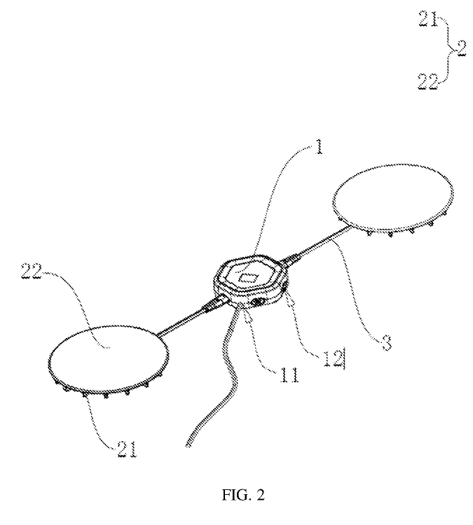

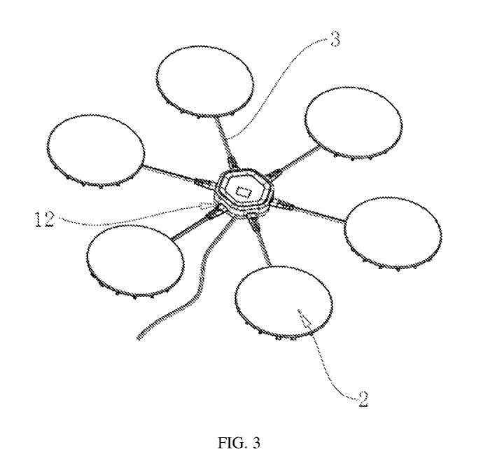

The present application is further described in detail below with reference to FIGS. 1-5.

An embodiment of the present application discloses a smart food warming apparatus. Referring to FIGS. 1-3, the smart food warming apparatus includes a main controller 1 and a plurality of subsidiary warming plates 2. The main controller 1 is provided with a power interface 11 and a plurality of operational interfaces 12, and the number of the operational interfaces 12 is the same as that of the subsidiary warming plates 2. The power interface 11 is configured for connecting to an external power supply to realize power supply to the main controller 1. A plurality of connection cables 3 are correspondingly arranged between the plurality of operational interfaces 12 and the plurality of subsidiary warming plates 2. The main controller 1 is electrically connected between one or more of the plurality of subsidiary warming plates 2 and one or more of the plurality of operational interfaces 12 through corresponding ones of the plurality of connection cables 3, and the plurality of connection cables 3 are detachably connected to the plurality of operational interfaces 12 respectively. The main controller 1 is configured to regulate operating states of the plurality of subsidiary warming plates 2.

The main controller 1 in this embodiment may be a Microcontroller Unit (MCU), which includes a Central Processing Unit (CPU), a memory, and additional peripheral circuits integrated on a single chip. Alternatively, the main controller 1 may be implemented as an existing controller to regulate operating parameters including power output, timing, on/off switching, and lock modes, which is intelligent and convenient. Specific components and operating principles of the main controller 1 will not be elaborated here. Meanwhile, the main controller 1 can be powered through the power interface 11 via connection to the household power grid (mains power), ensuring straightforward operation.

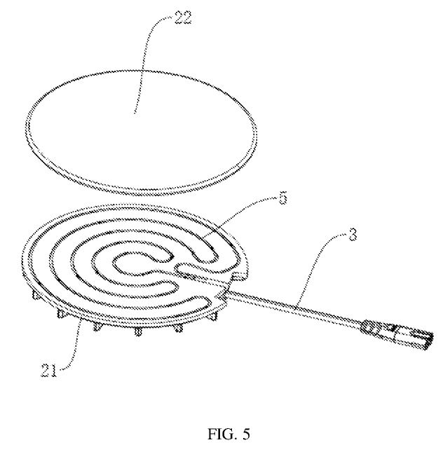

Further, referring to FIGS. 1 and 5, each subsidiary warming plate 2 includes a base 21, a placement portion 22, and a heating component (not shown). The placement portion 22 is configured to support a food container. The placement portion 22 covers the base 21 and encloses the heating component between the base 21 and the placement portion 22, thereby protecting the heating component and ensuring that the heating component can operate normally when powered on. Meanwhile, the base 21 and the placement portion 22 can be integrally formed by liquid silicone, and a wiring groove 5 is circumferentially formed on an upper surface of the base 21.

Correspondingly, the heating component may be a component used for realizing electrothermal conversion, such as an electric heating wire or a heating plate. Since the food warming apparatus in the present application is used to maintain dish temperature or provide heating to the dish in the dinner plate, and has a maximum operational temperature limit of 130℃ (SI unit: Celsius). In this embodiment, these heating components has the same function, and the specific type of the heating component will not be limited or described herein.

In addition, it should be noted that shapes of the main controller 1 and the subsidiary warming plates 2 can be flexibly changed according to usage requirements (such as circular, rectangular, rhombic, or other irregular shapes), and thus their specific shapes will not be limited herein.

Meanwhile, the base 21 is provided with a containing groove 211 is defined thereon. The base 21 is configured to abut against the dining table (or other placing surfaces) to enable the subsidiary warming plate 2 to be stably placed on the dining table, and the containing groove 211 is configured to accommodate the connection cable 3. The containing groove 211 is formed by the depression of the base 21 along a thickness direction thereof. When the connection cable 3 is in the containing groove 211, the connection cable 3 is clamped by the containing groove 211. Thus, when a subsidiary warming plate 2 does not need to be connected to the main controller 1 via a connection cable 3, the connection cable 3 can be stored in the containing groove 211, which reduces the space occupied by the subsidiary warming plate 2 and facilitates the stacked storage of the plurality of subsidiary warming plates 2.

Furthermore, a retaining ring (not shown) is protrudingly provided along periphery of the placement portion 22 for containing liquid. When a dinner plate is placed on the placement portion 22, the liquid spilled along the dinner plate is blocked by the retaining ring and stored on the placement portion 22, without spilling onto the dining table, thereby improving the overall cleanliness.

It should be mentioned here that the placement portion 22 may be made of silicone material. Taking advantage of properties of the silicone material including temperature resistance and stable physical and chemical properties, no abnormal noise will be generated when the dinner plate is placed on the placement portion 22, and the placement portion 22 is easy to clean.

Meanwhile, when the connection cable 3 is located in the containing groove 211, the subsidiary warming plate 2 may be used for supporting a dinner plate or serving as a pad. If the dinner plate currently holding dishes does not require heat preservation or heating (e.g., cold dishes), the subsidiary warming plate 2 can be used as a table pad, enhancing practical utility.

In another embodiment, each of the subsidiary warming plates 2 is provided with an insertion port 23. A distal end of the connection cable 3 opposite to an operational interface 12 is plug-mated with the insertion port 23, and a plug (not shown) is provided on the insertion port 23 for sealing the insertion port 23. Since the insertion port 23 is provided on the subsidiary warming plate 2, when the subsidiary warming plate 2 is not in use, the connection cable 3 can be detached from the insertion port 23, and the insertion port 23 can be sealed with the plug. In this way, the subsidiary warming plate 2 can be directly rinsed without foreign objects entering the insertion port 23, facilitating the cleaning of the subsidiary warming plate 2.

In addition, a supporting structure 212 is provided on the base 21, and the supporting structure 212 includes a plurality of convex ribs formed by protruding along the base 21. The supporting structure 212 disposed on the base 21 improves the heat dissipation capacity of the base 21 and reduce the probability of damage to the dining table or the placement surface caused by excessive temperature of the base.

Meanwhile, after the insertion port 23 is sealed with the plug, the placement portion 22 of the subsidiary warming plate 2 may also be used as a bone plate, and the subsidiary warming plate 2 only needs to be cleaned after use.

In an embodiment, the main controller 1 includes a storage compartment (not shown) formed thereon and configured to store the connection cables 3. The storage compartment may be formed by depression of a side wall of the main controller 1 toward a geometric center of the main controller 1, which improves the convenience of storing the connection cables 3.

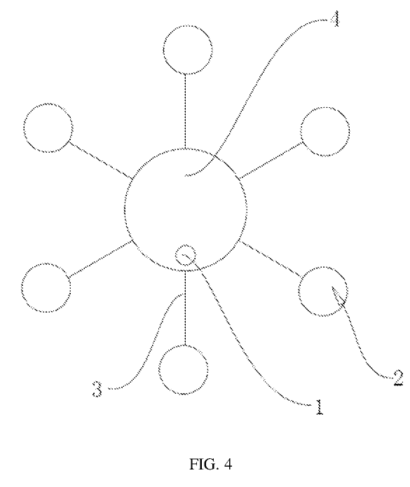

In yet another embodiment, referring to FIG. 4, the smart food warming apparatus further includes a master warming plate 4, and the main controller 1 is disposed on the master warming plate 4. The master warming plate 4 has the same components as the subsidiary warming plate 2, which will not be described in detail here. The integration of the main controller 1 onto the master warming plate 4 allows placement of dinner plates (e.g., soup bowls and soup pots) directly on the master warming plate 4, while the subsidiary warming plates 2 hold peripheral dishes. This creates a visually balanced arrangement with central vessels surrounded by plates,, without compromising the normal operation of the main controller 1, thereby effectively improving the space utilization.

The implementation principle of the smart food warming apparatus according to an embodiment of the present application includes: the main controller 1 is provided with the power interface 11 through which the power supply to the main controller is realized. Meanwhile, the main controller 1 is provided with a plurality of operational interfaces 12, and the number of the subsidiary warming plates 2 is adapted to the number of the operational interfaces 12. In addition, the main controller 1 and the subsidiary warming plates 2 are connected through the connection cables 3. Users can freely control the number of the subsidiary warming plates 2 connected to the main controller 1 as required. A subsidiary warming plate 2 can only operate when it is connected to the main controller 1 via a connection cable 3, while those not connected to the main controller 1 are in a non-operating state. This design plays a positive role in reducing the overall energy consumption of the food warming apparatus. Furthermore, the placement of the subsidiary warming plates 2 along the dining table can be flexibly adjusted, enhancing the space utilization of the dining table without affecting the heating or heat preservation effect of the dinner plates placed on the subsidiary warming plates 2. This design also contributes to improved heating or heat preservation effect of the dishes..

The above are all preferred embodiments of the present application, and they are not intended to limit the protection scope of the present application. Therefore, all equivalent changes made in accordance with the structure, shape, and principle of the present application shall be included within the protection scope of the present application.

### LIST OF REFERENCE NUMERAL S:

1, main controller

11, power interface

12, operational interface

2, subsidiary warming plate

21, base

211, containing groove

212, supporting structure

22, placement portion

23, insertion port

3, connection cable

4, master warming plate

5, wiring groove

What is claimed is:

1. A smart food warming apparatus, comprising:
a main controller; and
a plurality of subsidiary warming plates;
wherein the main controller is provided with a power interface configured for external connection to a power source to supply power to the main controller, and a plurality of operational interfaces corresponding in number to the plurality of subsidiary warming plates;
wherein a plurality of connection cables are respectively disposed between the plurality of operational interfaces and the plurality of subsidiary warming plates;
wherein the main controller is electrically connected between one or more of the plurality of subsidiary warming plates and one or more of the plurality of operational interfaces via corresponding ones of the plurality of connection cables;
wherein the plurality of connection cables are detachably connected to the plurality of operational interfaces, respectively; and
wherein the main controller is configured to regulate operating states of the plurality of subsidiary warming plates.

2. The smart food warming apparatus of claim 1, wherein each of the plurality of subsidiary warming plates comprises a base, and the base is provided with a containing groove, which is configured to accommodate one of the plurality of connection cables.

3. The smart food warming apparatus of claim 1, wherein each of the plurality of subsidiary warming plates comprises a placement portion configured to support a food container.

4. The smart food warming apparatus of claim 2, wherein when one of the plurality of connection cables is accommodated in a corresponding one of the containing grooves, a corresponding one of the plurality of subsidiary warming plates is used for supporting a dinner plate or serving as a pad.

5. The smart food warming apparatus of claim 1, wherein:
each of the plurality of subsidiary warming plates comprises an insertion port;
a distal end of one of the plurality of connection cables opposite to a corresponding one of the plurality of operational interfaces is removably inserted into the insertion port of a corresponding one of the plurality of subsidiary warming plates; and
a sealing plug is provided at the insertion port and configured to seal the insertion port.

6. The smart food warming apparatus of claim 2, wherein the base is provided with a supporting structure.

7. The smart food warming apparatus of claim 1, wherein the main controller comprises a storage compartment formed thereon and configured to store the plurality of connection cables.

8. The smart food warming apparatus of claim 1, further comprising:
a master warming plate, and the main controller is disposed on the master warming plate.

9. The smart food warming apparatus of claim 1, wherein each of the plurality of subsidiary warming plates comprises a base and a placement portion connected via liquid silicone; and a wiring groove is circumferentially formed on an upper surface of the base.
